(19) United States
(12) Patent Application Publication
(10) Pub. No.: US 2011/0184754 A1
(43) Pub. Date: Jul. 28, 2011

(54) SYSTEM AND METHOD FOR REMOTE HEALTH CARE MANAGEMENT

(75) Inventors: Kun-kook PARK, Yongin-si (KR); Kwang-hyeon LEE, Yongin-si (KR)

(73) Assignee: SAMSUNG ELECTRONICS CO., LTD., Suwon-si (KR)

(21) Appl. No.: 13/014,820

(22) Filed: Jan. 27, 2011

(30) Foreign Application Priority Data
Jan. 28, 2010 (KR) 10-2010-0008045

(51) Int. Cl. G06Q 50/00; G06Q 10/00

(52) U.S. Cl. 705/2

(57) ABSTRACT

A remote health care method, the method includes generating a user intention from usage data of a user provided by a health care terminal, generating a health care professional intention about the user, generating a personalized recommendation which adjusts compliance of the user with respect to remote health care management based on the user intention and the health care professional intention, and providing the personalized recommendation to the health care terminal.

### CROSS-REFERENCE TO RELATED APPLICATIONS

This application claims priority to Korean Patent Application No. 10-2010-0008045, filed on Jan. 28, 2010, and all the benefits accruing therefrom under 35 U.S.C. §119, the content of which in its entirety is herein incorporated by reference.

### BACKGROUND

1. Field

The present disclosure generally relates to systems and methods for remote health care management.

2. Description of the Related Art

Remote health care generally involves health care performed by health care professionals using a specific device and communication technology for managing health or diseases of patients at a remote place. The health care professionals monitor health status of the patients at the remote place, take appropriate actions according to a result of the monitoring, and manage the health or diseases of the patients, thereby maintaining and improving the health of the patients.

In health care programs for managing health of the patients using the remote health care, appropriate intervention by the health care professionals using collected information about the patients is a significant factor for successful patient management. The appropriate intervention motivates and stimulates the patients to improve their health and overcome their diseases, and is conducive to efficient management of the patients. Furthermore, an effect of remote health care can be substantially improved when the patients comply well with health care professional's intentions to maintain and substantially improve their health.

Compliance of the patients is evaluated by monitoring behaviors and attitudes of the patients who participate in the health care program, and the health care professionals perform health management by appropriately intervening with consideration of the evaluated compliance, thereby improving overall health of the patients.

### SUMMARY

Provided are systems and methods for remote health care management. Also provided are computer-readable recording mediums having a program recorded thereon for executing the remote health care methods.

Additional aspects will be set forth in part in the description which follows and, in part, will be apparent from the description, or may be learned by practice of the presented embodiments.

According to an embodiment of the present invention, a remote health care method comprises generating a user intention from usage data of a user provided by a health care terminal, generating a health care professional intention about the user, generating a personalized recommendation that adjusts compliance of the user with respect to remote health care management based on the user intention and the health care professional intention, and providing the personalized recommendation to the health care terminal.

According to an embodiment of the present invention, a remote health care system comprises a health care terminal generating information generated due to user's interaction with respect to a function and/or contents included in a remote health care management program as usage data of the user, and a server generating a user intention from the usage data of the user provided by the health care terminal, generating a health care professional intention about the user, and generating a personalized recommendation that adjusts compliance of the user with respect to remote health care management based on the user intention and the health care professional intention.

According to an embodiment of the present invention, a health care terminal comprises a user interface unit to display at least one of a function and contents included in a remote health care management program, performing an interaction of a user with respect to the displayed function and/or contents, and a data processing unit to generate usage data of the user due to the interaction of the user performed by the user interface unit, storing the usage data of the user or transmitting the usage data of the user to a server disposed at a remote place.

### BRIEF DESCRIPTION OF THE DRAWINGS

The above and other aspects, advantages and features of this disclosure will become more apparent by describing in further detail embodiments thereof with reference to the accompanying drawings, in which:

FIG. 1 illustrates a concept of an embodiment of a remote health care system according to the present disclosure;

FIG. 2 is a block diagram of an embodiment of a structure of a health care terminal illustrated in FIG. 1;

FIG. 3 is a block diagram of an embodiment of a server of the remote health care system of FIG. 1;

FIG. 4 is a block diagram of an embodiment of a user intention generation unit illustrated in FIG. 3;

FIG. 5 is a block diagram of an embodiment of a health care professional intention generation unit illustrated in FIG. 3;

FIG. 6 is a block diagram of an embodiment of a personalized content generation unit illustrated in FIG. 3;

FIG. 7 is a block diagram of an embodiment of a personalized recommendation generation unit illustrated in FIG. 3;

FIGS. 8A through 8D illustrate embodiments of a screen displayed by a user interface (“I/F”) unit of FIG. 2;

FIG. 9 illustrates an embodiment of generating a usage data set;

FIG. 10A illustrates an embodiment of a structure of the usage data set illustrated in FIG. 9, and FIG. 10B illustrates an embodiment of the usage data set generated when a user measures a blood pressure using the health care terminal;

FIG. 11 illustrates an embodiment of generating a user intention;

FIGS. 12A and 12B illustrate embodiments of generating a health care professional intention;

FIG. 13 is a flowchart illustrating an embodiment of an operation of generating a personalized recommendation, according to the present disclosure; and

FIG. 14 is a flowchart illustrating an embodiment of an operation of generating personalized contents, according to the present disclosure.

### DETAILED DESCRIPTION

Reference will now be made in detail to embodiments, examples of which are illustrated in the accompanying drawings, wherein like reference numerals refer to like elements throughout. In the present embodiment, the present embodiments may have different forms and should not be construed as being limited to the descriptions set forth herein. Accordingly, the embodiments are merely described below, by referring to the figures, to explain aspects of the present description.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, the present invention will be described in detail by explaining exemplary embodiments of the invention with reference to the attached drawings. Like reference numerals in the drawings denote like elements.

Before explaining the disclosed embodiments in detail, terms used in the present invention will be summarized as below.

Usage data of a user is obtained based on an interaction between a health care terminal and the user and includes information such as a selection time, a selected button, or a touch panel, for example, when the user selects the button or the touch panel related to a remote health care management program recorded on the health care terminal. A user intention may be extracted from the usage data of the user collected for a predetermined amount of time and includes information that indicates user information such as tendency, trend, will, or habit with regard to application software (hereinafter, also referred to as an “application”) related to remote health care management recorded on the health care terminal (hereinafter, referred to as a remote health care management program). At least one user intention may be present by classifying the usage data of the user obtained based on the interaction between the health care terminal and the user using a predetermined classification method. A health care professional intention may be differently set according to users of health care terminals and may be set by combining information obtained through a user interview and/or information about current disease status of the user. In detail, the heath professional intention indicates information about health care terminal instructions, and at least one health care professional intention may be present, like the embodiment of the user intention.

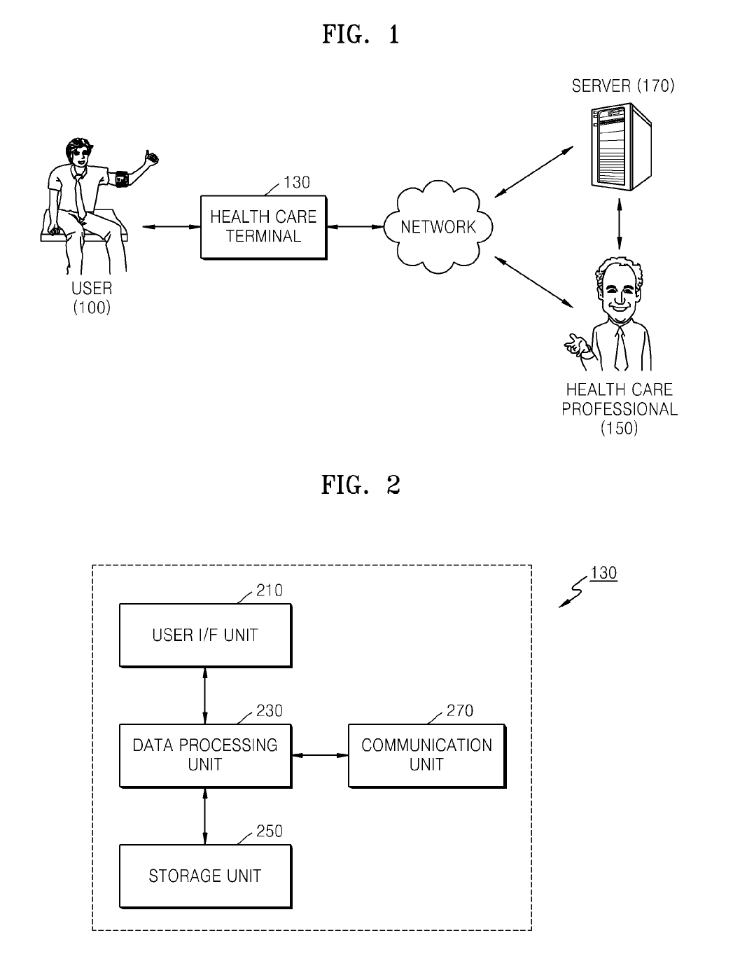

FIG. 1 illustrates a concept of an embodiment of a remote health care system according to the present disclosure. Referring to FIG. 1, the embodiment of the remote health care system according to the present invention includes a health care terminal 130 and a server 170. The health care terminal 130 and the server 170 may communicate with each other via a network, e.g., a wired or wireless network. The health care terminal 130 may be designed as a stand-alone device including predetermined functions related to the remote health care management, i.e., various remote health care management programs. In one embodiment, the health care terminal 130 may be implemented by including applications related to the remote health care management and recorded on a mobile device such as a mobile phone, a personal digital assistants (“PDA”) or other various types of mobile devices, or by being downloaded from a software-based online store such as the App store (not shown), a web server (not shown), or by being mounted in a home computer or a home networking device such as a residential gateway.

The health care terminal 130 includes applications related to the remote health care management, and each of the applications includes various functions and/or contents. The remote health care management program recorded on the health care terminal 130 may include a main program provided as a default, and a subprogram that can be reconfigured according to the user intention. A user 100 of the health care terminal 130 generates information by selecting functions and/or contents included in the remote health care management program, and information related to a time at which the user 100 has selected the information, i.e., the usage data. The usage data of the user 100 generated by the health care terminal 130 is provided to the server 170 via the network in real-time or periodically. A measurement result obtained by the user 100 by executing the remote health care management program recorded on the health care terminal 130 may be stored in a memory or may be provided to the server 170 via the network.

The server 170 generates information that indicates a user intention by receiving the usage data of the user 100 provided by the health care terminal 130 in real-time or periodically, calculates a difference between the user intention and a health care professional intention about the user 100, and generates a personalized recommendation and/or personalized contents that are used to adjust compliance of the user 100 for the remote health care management based on the calculated difference. The personalized contents generated by the server 170 are fed back to the health care terminal 130, and the personalized recommendation is referred to when information about the health care professional intention about the user 100 is generated. In one embodiment, the health care professional 150 may intervene with the user 100 efficiently according to the personalized recommendation generated by the server 170. In one embodiment, the health care professional 150 may reconfigure the subprogram of the remote heath care management program according to the information that indicates the user intention generated by the server 170 and may provide the reconfigured subprogram to the health care terminal 130. In one embodiment, when it is determined that there is any problem with accessing the health care terminal 130 based on a frequency of use of items included in the subprogram of the remote health care management program and a habit thereof, for example, a user interface (“IF”) may be edited so as to substantially improve user accessibility. The remote health care management program may be edited to be optimized according to users, based on the information that indicates the user intention generated by the server 170,

FIG. 2 is a block diagram of a structure of the health care terminal 130 illustrated in FIG. 1. In one embodiment, the health care terminal 130 may include a power supply unit (not shown) for supplying power required for operations of elements of the remote health care system of FIG. 1. However, the above mentioned embodiment is not a characteristic structure of the present disclosure and thus, a description thereof will not be provided here. Similarly, it will be understood by one of ordinary skill in the art that the health care terminal 130 may include various other types of structures.

Referring to FIG. 2, the health care terminal 130 may include a user I/F unit 210, a data processing unit 230, a storage unit 250, and a communication unit 270.

In one embodiment, the user I/F unit 210 may include a touch screen, or may include at least one of a screen, a touch panel, and a button, but the embodiment of the present invention is not limited thereto. The user I/F unit 210 may display various functions and/or contents included in the remote health care management program stored in the storage unit 250 on a screen via the data processing unit 230 due to the interaction between the health care terminal 130 and the user 100. When the user selects an item among a function item and/or a content item displayed on the screen, the user I/F unit 210 may provide the function and/or the content selected by the user 100 and information about a time at which the user 100 has selected the item, to the data processing unit 230. The remote health care management program is executed according to the function item and/or the content item selected by the user 100, resultantly a measurement value, for example, may be generated. The result of execution may be stored in the storage unit 250 via the data processing unit 230 or may be provided to the server 170 via the communication unit 270. Examples of function items related to the remote health care management may include ‘measurement’, ‘message’, ‘education’, ‘information’, ‘search’, ‘history’, ‘exercise’, ‘nutrition’, ‘survey’, for example, but the present invention is not limited thereto and may include various other function items. Examples of content items related to the remote health care management may include ‘how to use a health care terminal’, ‘how to use a blood glucose measuring device’, ‘how to input nutrition information’, for example, but the present invention is not limited thereto, and may include various other content items. In one embodiment, contents related to the remote health care management may be included in functions in a broad sense, and an education item from among the function items may be included in contents in a limited sense. In one embodiment, some or all of the function items and the content items included in the remote health care management program may be used as the usage data of the user 100.

The data processing unit 230 may output the function item and/or the content item selected by the user 100 and the information about the selected time as the usage data of the user 100 to the communication unit 270 in real-time or may store them in the storage unit 250. In one embodiment, when receiving a request to transmit the usage data of the user 100 from the server 170 via the communication unit 270, the data processing unit 230 may read the usage data of the user 100 stored in the storage unit 250 for a predetermined amount of time and may output the read usage data of the user 100 to the communication unit 270. In one embodiment, the data processing unit 250 may periodically read the usage data of the user 100 stored in the storage unit and may output the read usage data of the user 100 to the communication unit 270. The data processing unit 230 may extract a user intention from the usage data of the user 100 by applying a substantially same editing and classification method as that of the server 170 to the usage data of the user 100 stored in the storage unit 250, may display on the user I/F unit 210 the personalized recommendation based on the difference between the extracted user intention and the health care professional intention stored in the storage unit 250, or may inform the user 100 of a personalized recommendation via voice, for example.

The storage unit 250 stores at least one remote health care management program, and the usage data of the user 100, which is related to the various functions and/or contents included in the remote health care management program, is stored in the storage unit 250 according to the interaction between the user I/F unit 210 and the user 100. In one embodiment, the storage unit 250 may store the health care professional intention provided via the server 170 or directly from the health care professional 150. In one embodiment, the remote health care management program may be stored in the storage unit 250 in advance. In one embodiment, the remote health care management program downloaded by the user 100 from the software-based online store such as the App store (not shown) or the web server (not shown) may be stored in the storage unit 250. In one embodiment, the remote health care management program received in response to a request of the user 100 to the sever 170 may be stored in the storage unit 250. In one embodiment, the remote health care management program may be reconfigured as a subprogram so as to be adapted according to the user 100 in response to the user intention and is transmitted by the server 170, or the reconfigured subprogram of the remote health care management program may be stored in the storage unit 250.

The communication unit 270 transmits the usage data of the user 100 provided by the data processing unit 250 to the server 170. In the present embodiment, the communication unit 270 may transmit the usage data of the user 100 provided by the data processing unit 250 to the server 170 in real-time at a time at which the user 100 has selected a predetermined function or contents, may transmit the usage data of the user 100 to the server 170 when receiving the request to transmit the usage data of the user 100 from the server 170, or may periodically transmit the usage data of the user 100 to the server 170.

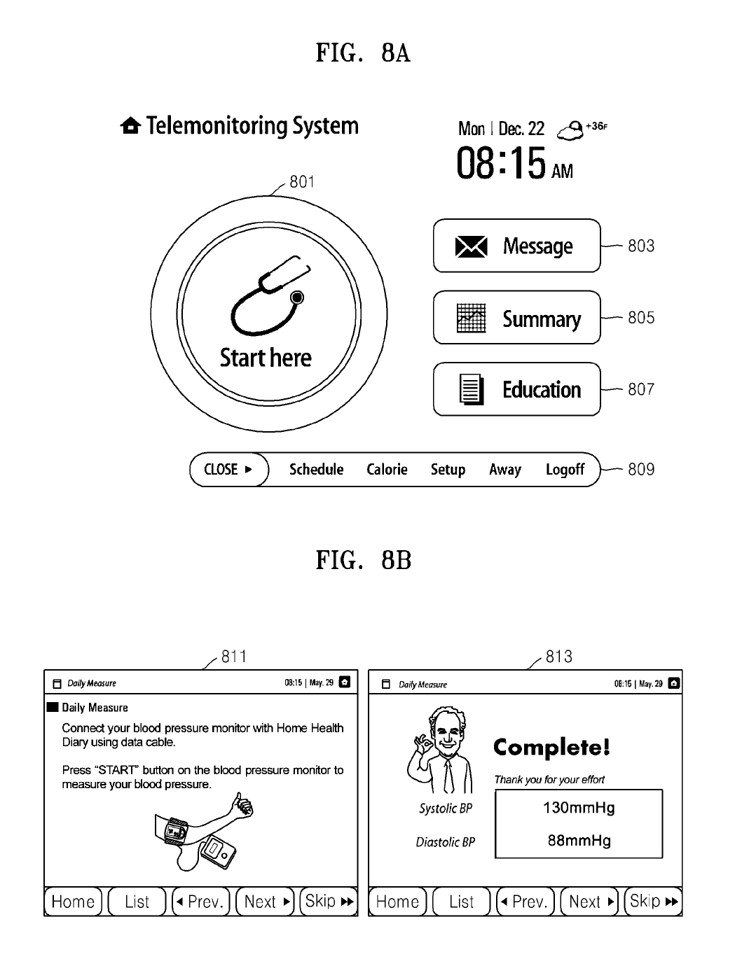

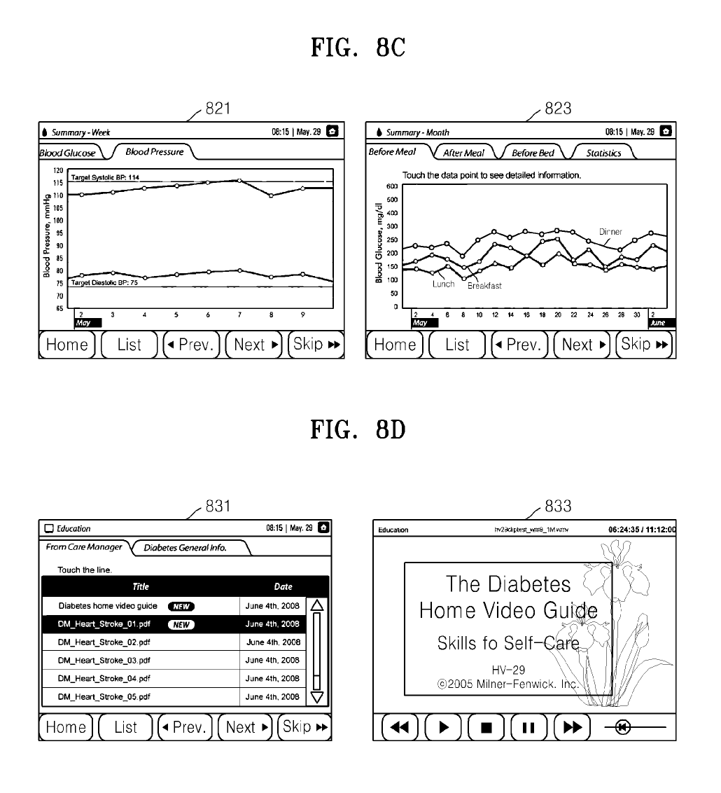

Embodiments of the screen displayed by the user I/F unit 210 of the health care terminal 130 illustrated in FIG. 2 are illustrated in FIGS. 8A through 8D. FIG. 8A illustrates an embodiment of a main screen of the remote health care management program including items such as measurement 801, message 803, summary 805, education 807, and a pop-up menu 809, for example, but the embodiment of the present invention is not limited thereto and may include various other types of items. FIG. 8B illustrates an embodiment of a screen when blood pressure is measured in the measurement 801, including an instruction screen 811 and a result screen 813, for example. FIG. 8C illustrates an embodiment of a screen that indicates history in the summary 805, including a weekly blood pressure graph 821 and a monthly blood glucose graph 823, for example. FIG. 8D illustrates an embodiment of a screen that indicates the education 807, including an education list screen 831 and an education reproduction screen 833.

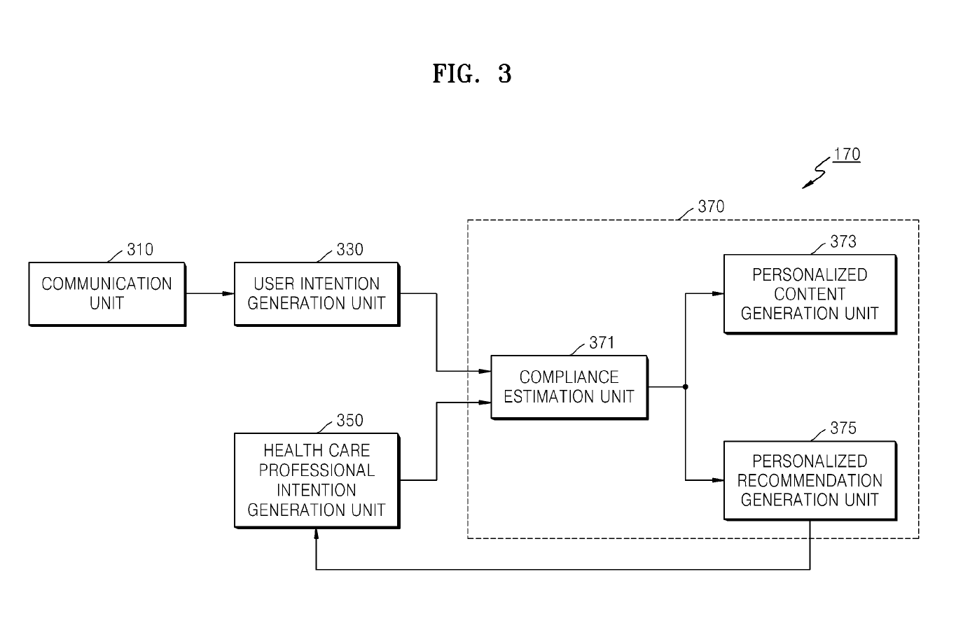

FIG. 3 is a block diagram of an embodiment of the server 170 of the remote health care system of FIG. 1. Referring to FIG. 3, the server 170 may include a communication unit 310, a user intention generation unit 330, a health care professional intention generation unit 350, and a compliance adjustment unit 370. In one embodiment, the compliance adjustment unit 370 may include a compliance estimation unit 371, a personalized content generation unit 373, and a personalized recommendation generating unit 375. The server 170 may include at least one of the personalized content generation unit 373 and the personalized recommendation generating unit 375, or the personalized content generation unit 373 and the personalized recommendation generating unit 375 may be integrated as one body to be implemented. The above-described elements of the server 170 may be implemented as a plurality of processors or may be implemented as one processor by integrating all of the elements as one body.

Referring to FIG. 3, the communication unit 310 receives the usage data of the user 100 transmitted from the health care terminal 130 via the network such as the wired or wireless network and provides the usage data of the user 100 to the user intention generation unit 330.

The user intention generation unit 330 generates information that indicates a user intention using the usage data of the user 100 provided by the communication unit 310.

The health care professional intention generation unit 350 generates information that indicates a health care professional intention in regard to the user 100 using information input by the health care professional 150 and user profile information. In one embodiment, when a personalized recommendation that is generated in advance for the user 100 is present, the health care professional intention generation unit 350 may refer to the personalized recommendation.

The compliance adjustment unit 370 generates a personalized recommendation and/or personalized contents that can adjust compliance of the user 100 for the remote health care management based on the user intention and the health care professional intention. The compliance adjustment unit 370 will now be described in greater detail below.

The compliance estimation unit 371 estimates current compliance based on the user intention and the health care professional intention. In detail, the compliance of the user 100 in regard to the remote health care management reflects the difference between the user intention and the health care professional intention, and the compliance estimation unit 371 estimates that, as the difference increases, the compliance of the user 100 decreases, and as the difference decreases, the compliance of the user 100 increases. In one embodiment, a factor for determining the compliance of the user 100 may be any environmental or natural factor other than the difference between the user intention and the health care professional intention. In the present embodiment, when the health care professional 150 or a knowledge manager sets an amplification ratio in advance with respect to a predetermined function or content item according to an importance of each function or content item, a degree of emergency of a situation and a degree of the difference between the user intention and the health care professional intention related to the predetermined function or content item may be obtained, thereby the compliance estimation unit 371 may obtain a final difference by applying the amplification ratio to the predetermined function or content item. A predetermined normalization function is applied to the user intention and thus, the user intention may be indicated by numbers. Similarly, a substantially same normalization function as that applied to the user intention may be applied to the health care professional intention and thus, the health care professional intention may also be indicated by numbers.

The personalized content generation unit 373 generates personalized contents using estimated current compliance, content knowledge information and/or user preference information, thereby provides the personalized contents to the health care terminal 130.

The personalized recommendation generation unit 375 generates a personalized recommendation using the estimated current compliance and/or intervention evidence history, thereby provides the personalized recommendation to the health care terminal 130 and the health care professional 150.

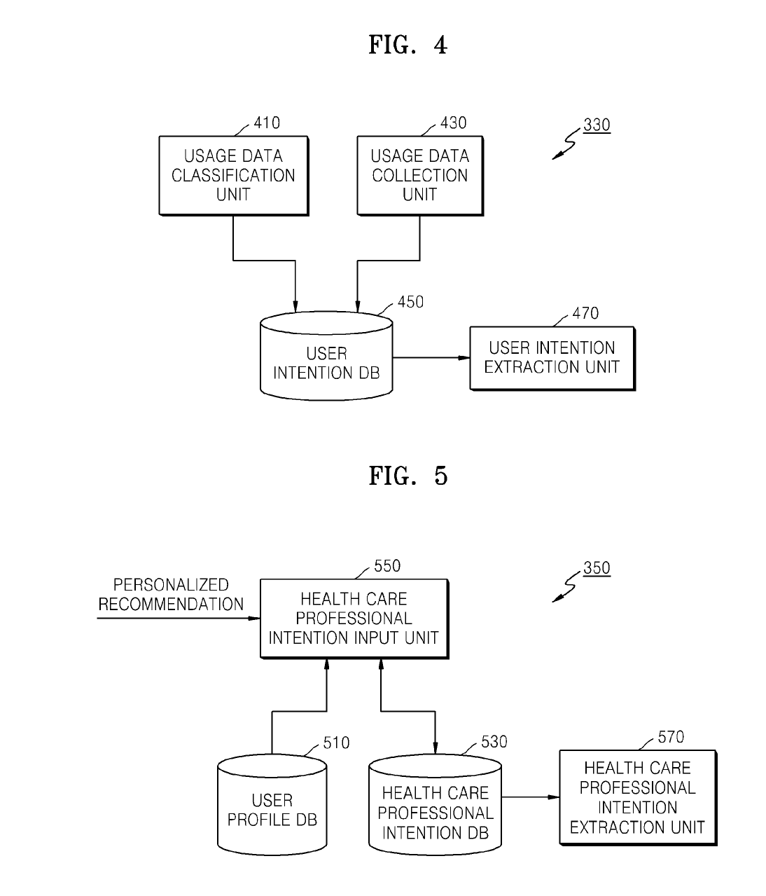

FIG. 4 is a detailed block diagram of an embodiment of the user intention generation unit 330 illustrated in FIG. 3. Referring to FIG. 4, the user intention generation unit 330 may include a usage data classification unit 410, a usage data collection unit 430, a user intention database (“DB”) 450, and a user intention extraction unit 470.

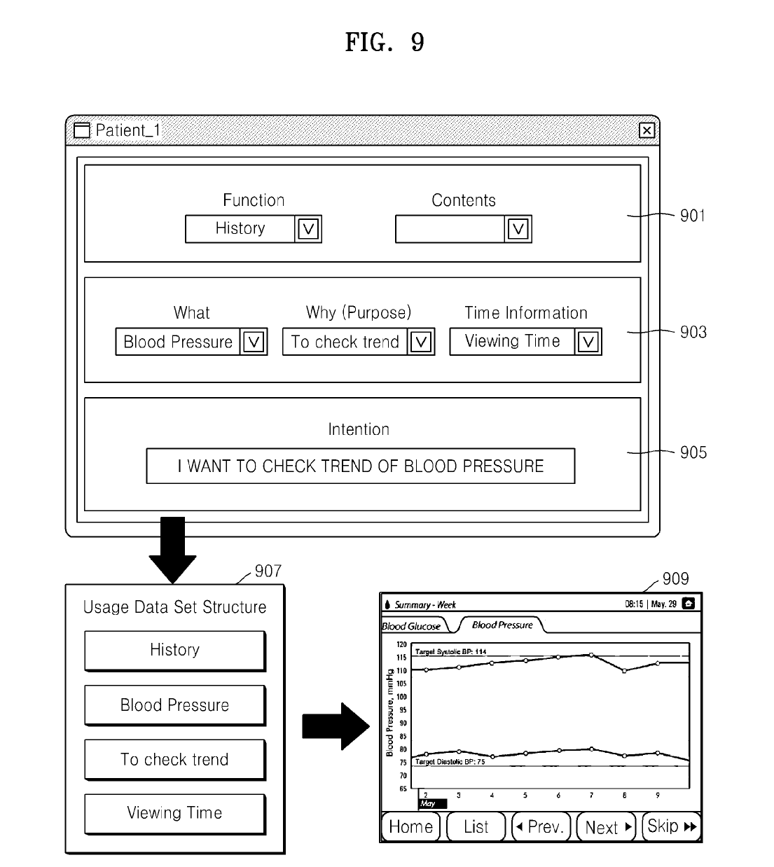

The usage data classification unit 410 edits and classifies usage data that is generated due to the interaction between the user and the health care terminal 130, thereby generates a usage data set. The usage data is edited and classified according to an attribute of a function item or a content item included in the remote health care management program so as to extract the user intention from the usage data, and the generated usage data set is set in the user intention DB 450. The usage data set that is edited, classified and generated by the usage data classification unit 410 may be embedded in the remote health care management program recorded on the health care terminal 130 and may be stored in the storage unit 250. In one embodiment, one usage data set may be connected to one user intention, but the present invention is not limited thereto, and a plurality of usage data sets may be combined with one another to be connected to one user intention. FIG. 9 illustrates an embodiment of generating a usage data set. Referring to FIG. 9, when ‘history’ is selected from a first classification item 901 and ‘blood pressure’, ‘to check trend’, and ‘viewing time’ are selected from second through fourth classification items 903, and an intention 905 is extracted as ‘I want to check trend of blood pressure’, for example. The extracted intention 905 is generated as a usage data set 907 including items, such as ‘history’, ‘blood pressure’, ‘to check trend’, and ‘viewing time’. The usage data set 907 generated from the extracted intention 905 is embedded in a blood pressure graph screen 909 according to viewing time and is generated when the user 100 selects ‘Next’ that indicates termination of a predetermined function from the blood pressure graph screen 909 according to viewing time. An operation of editing and classifying the usage data may be performed when the remote health care management program is executed or new contents are added to the remote health care management program.

Table 1 shows an embodiment in which intention factors for each function are extracted and classified from the remote health care management program recorded on the health care terminal 130. In detail, Table 1 shows that the intention factors are classified so that user's interaction for each function item can be indicated by including time.

TABLE 1

| First classification | | Second classification | | Third classification | | Fourth classification | |
|---|---|---|---|---|---|---|---|
| | Classification | | Classification | | Classification | How | Classification |
| Function | code | About What | code | How or Why | code | Frequent | code |
| Measurement | A | Blood glucose | A | | | Frequency of | A |
| | | measurement | | | | behavior | |
| | | Blood | B | | | Time | B |
| | | pressure | | | | required for | |
| | | measurement | | | | behavior | |
| | | Weight | C | | | Number of | C |
| | | measurement | | | | clicks of unit | |
| | | | | | | function | |
| | | Temperature | D | | | | |
| | | Measurement | | | | | |
| | | Exercise | E | | | | |
| | | measurement | | | | | |
| Message | B | Read received | A | Message read | A | Frequency of | A |
| | | message | | ratio | | behavior | |
| | | Reply to | B | Message reply | B | Time | B |
| | | received | | ratio | | required for | |
| | | message | | | | behavior | |
| | | Write new | C | Message | C | Number of | C |
| | | message | | generation | | clicks of unit | |
| | | | | ratio | | function | |
| Education | C | Diabetes | A | General | A | Frequency of | A |
| | | | | information | | behavior | |
| | | Blood | B | Prevention | B | Time | B |
| | | pressure | | information | | required for | |
| | | | | | | behavior | |
| | | Weight | C | Living habit | C | Number of | C |
| | | | | information | | clicks of unit | |
| | | | | | | function | |
| | | Nutrition | D | | | | |
| | | Living habits | E | | | | |
| Information | D | News | A | Hygiene | A | Frequency of | A |
| | | | | | | behavior | |
| | | Health | B | New | B | Time | B |
| | | information | | technology | | required for | |
| | | | | | | behavior | |
| | | | | General | C | Number of | C |
| | | | | health | | clicks of unit | |
| | | | | | | function | |
| Search | E | General | A | Drug | A | Frequency of | A |
| | | health | | information | | behavior | |
| | | information | | | | | |
| | | General other | B | | | Time | B |
| | | information | | | | required for | |
| | | | | | | behavior | |
| | | | | | | Number of | C |
| | | | | | | clicks of unit | |
| | | | | | | function | |
| History | F | Day | A | Blood glucose | A | Frequency of | A |
| | | | | before meal | | behavior | |
| | | Week | B | Blood glucose | B | Time | B |
| | | | | after meal | | required for | |
| | | | | | | behavior | |
| | | Month | C | Weight | C | Number of | C |
| | | | | | | clicks of unit | |
| | | | | | | function | |
| | | Total | D | Blood | D | | |
| | | | | pressure | | | |
| Exercise | G | Type of | A | Walking | A | Frequency of | A |
| | | exercise | | | | behavior | |
| | | Quantity of | B | Jogging | B | Time | B |
| | | exercise | | | | required for | |
| | | | | | | behavior | |
| | | | | Golf | C | Number of | C |
| | | | | | | clicks of unit | |
| | | | | | | function | |
| | | | | Tennis | D | | |
| | | | | Aerobics | E | | |
| | | | | Cycling | F | | |
| Nutrition | H | Type of food | A | Protein | A | Frequency of | A |
| | | | | | | behavior | |
| | | Intake amount | B | Carbohydrate | B | Time | B |
| | | of food | | | | required for | |
| | | | | | | behavior | |
| | | | | Fat | C | Number of | C |
| | | | | | | clicks of unit | |
| | | | | | | function | |
| Survey | I | Mental state | A | Response | A | Frequency of | A |
| | | | | ratio | | behavior | |
| | | Occurrence of | B | | | Time | B |
| | | symptom | | | | required for | |
| | | | | | | behavior | |
| | | | | | | Number of | C |
| | | | | | | clicks of unit | |
| | | | | | | function | |

Referring to Table 1, in the first classification, function items are largely classified, and in the second classification, it is classified whether a user intention ‘for what’ from among the function items of the first classification is present, and in the third classification, a user intention for ‘how or why’ with respect to the result of the second classification is classified, and in the fourth classification, how frequent, how long, and how many times a predetermined function is used, are classified by adding time information about user's behavior. In one embodiment, in a case of a ‘history’ included in the first classification is selected, order of the second classification and the third classification may be reversed.

In the present embodiment, a user intention is set to correspond to a health care professional intention, a function item connected to a user intention and detailed items according to classifications are defined in advance, and function items included in the usage data generated from the interaction between the health care terminal 130 and the user 100 and detailed items according to classifications are combined with one another, so that a final user intention related to a predetermined function can be obtained. In one embodiment, when the user 100 selects how to use a blood glucose measuring device from among how to use a device, and how to input nutrition information included in the education item of the function items, for example, a user intention such as ‘I want to use the health care terminal 130 well’ may be obtained, and the usage data set and the user intention may be connected to each other.

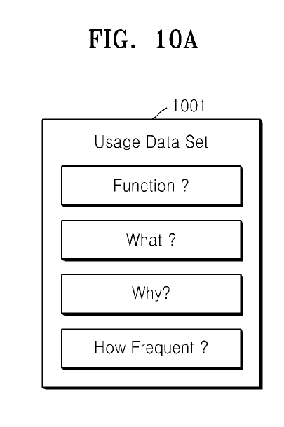

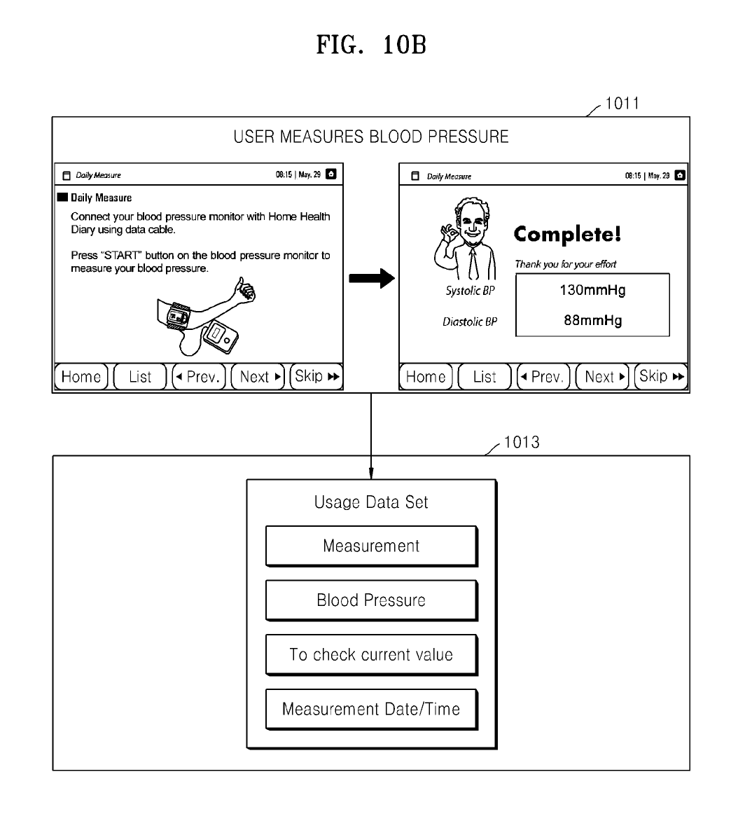

The usage data collection unit 430 collects the usage data of the user 100 provided by the health care terminal 130 and stores the usage data of the user 100 in the user intention DB 450. In one embodiment, when the user uses a predetermined function item included in the remote health care management program recorded on the health care terminal 130, for example, the usage data set including information, such as ‘what’, ‘why’, ‘when’, and ‘how long’, is stored in the user intention DB 450. An embodiment of a structure of the usage data set stored in the user intention DB 450 is shown in FIG. 10A, and an example of the usage data set generated when the user 100 measures blood pressure using the health care terminal 130 is shown in FIG. 10B. In detail, referring to FIG. 10A, an embodiment of a usage data set 1001 may include items such as ‘function’, ‘what’, ‘why’, and ‘how frequent’, for example. Referring to FIG. 10B, when the user 100 measures a blood pressure using the health care terminal 130, a preparation screen and a result screen of a screen 1011 related to blood pressure measurement are sequentially displayed on the user I/F unit 210. When the user 100 selects the item ‘Next’ that indicates completion of a predetermined function from the result screen of the right side of the blood pressure measurement screen 1011, a usage data set 1013 related to blood pressure measurement may be generated. In one embodiment, even when the result screen is displayed on the user I/F unit 210 and the item ‘Home’ or ‘List’ that indicates completion of a predetermined function other than the item ‘Next’ is selected, the usage data set 1013 related to blood pressure measurement may be generated.

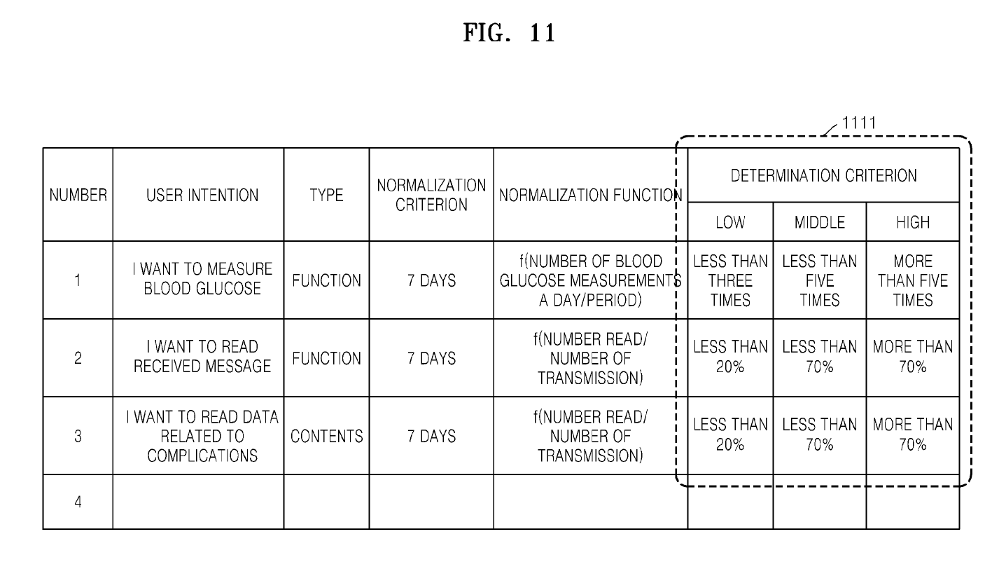

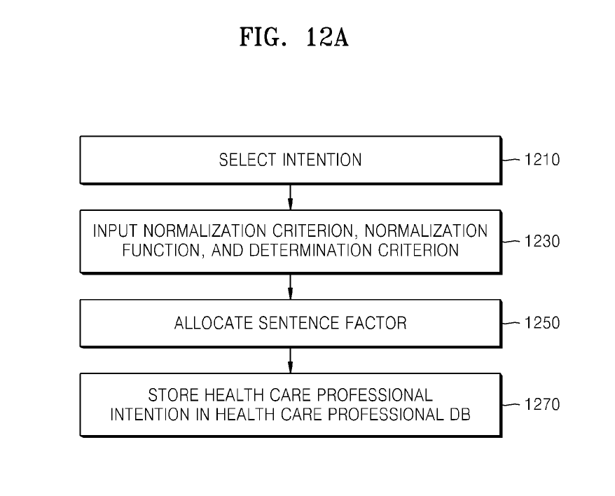

The user intention extraction unit 470 extracts a user intention from the usage data set that is collected by the usage data collection unit 430 and stored in the user intention DB 450, by referring to the usage data set that is edited and classified by the usage data classification unit 410 and stored in the user intention DB 450. In the present embodiment, the extracted user intention is normalized as a predetermined value that may be used as a determination criterion, via a normalization function corresponding to an intention type and a normalization criterion time. When the user intention that is normalized as the predetermined value is changed into a sentence, a user current intention may be intuitively indicated to the health care professional 150. Examples of sentences in which the user intention normalized as the predetermined value is changed, may include ‘a patient A wants to do blood glucose measurement well’, ‘a patient A can barely read a message received from another person’, and ‘a patient A wants to read data related to complications but finds it difficult’, or various other sentences. An embodiment of an operation of extracting the user intention is shown in FIG. 11. Referring to FIG. 11, when the user intention that involves ‘I want to measure blood glucose’ is extracted from the usage data, if an intention type is set as ‘function’, a normalization criterion is set as ‘seven days’ and a normalization function, such as ‘f(number of blood glucose measurements a day/period)’, is applied, normalized values ‘less than three times’, ‘less than five times’, and ‘more than five times’, which correspond to determination criteria ‘low’, ‘middle’, and ‘high’, may be obtained from the usage data related to blood glucose measurement due to the interaction between the user and the health care terminal 130 for seven days. A normalized value 1111 may be used as comparison data for estimating the compliance of the user 100 with respect to further remote health care management.

FIG. 5 is a detailed block diagram of the health care professional intention generation unit 350 illustrated in FIG. 3. Referring to FIG. 5, the health care professional intention generation unit 350 may include a user profile DB 510, a health care professional intention DB 530, a health care professional intention input unit 550, and a health care professional intention extraction unit 570.

The user profile DB 510 stores personal information including fact information and situation information about the user 100. The fact information may be information regarding fact of the user such as the current health status of the user 100, for example, and the situation information may be information regarding situation of the user such as living habits, preference, ability to use an information device, the field of concerns, the degree of education, or various other types of indirect information, which is generated by referring to an interview, a personal profile, or various other types of sources.

The health care professional intention input unit 550 inputs a health care professional intention to the user 100 based on the personal information about the user 100 that is read by the health care professional 150 from the user profile DB 510, and stores the health care professional intention in the health care professional intention DB 530. As an example of the input health care professional intention, personal information such as “a patient A is a 75 year old woman who suffers from chronic diseases, such as hyperpiesia and diabetes. She is a little overweight. At present, she does not exercise regularly due to having a hip-joint disease and needs correction of living habits including exercise. If she remains in the current state, complications, such as a stroke, may occur. Also, she is an extrovert and likes to interact with people.” about the patient A, for example, is stored in the user profile DB 510. In correspondence to the personal information about the patient A, the health care professional 150 may input intentions such as “education for alerting the patient A to the danger of complications, such as a stroke caused by diabetes, is required, and habits of monitoring blood pressure more than twice a day and checking blood glucose regularly more than three times a day should be kept. In particular, management of blood glucose through soft exercise that is regularly done is required. Also, participation in a community related to exercise is desirable.”, for example.

The normalization function and the determination criterion that are used when the user intention corresponding to a health care professional intention is normalized so as to normalize the health care professional intention, are stored in advance in the health care professional intention DB 530. In the present embodiment, a personalized determination criterion may be applied to the user 100 in consideration of personal information about the user 100. In one embodiment, a health care professional intention may be maintained in a one-to-one correspondence with the user intention.

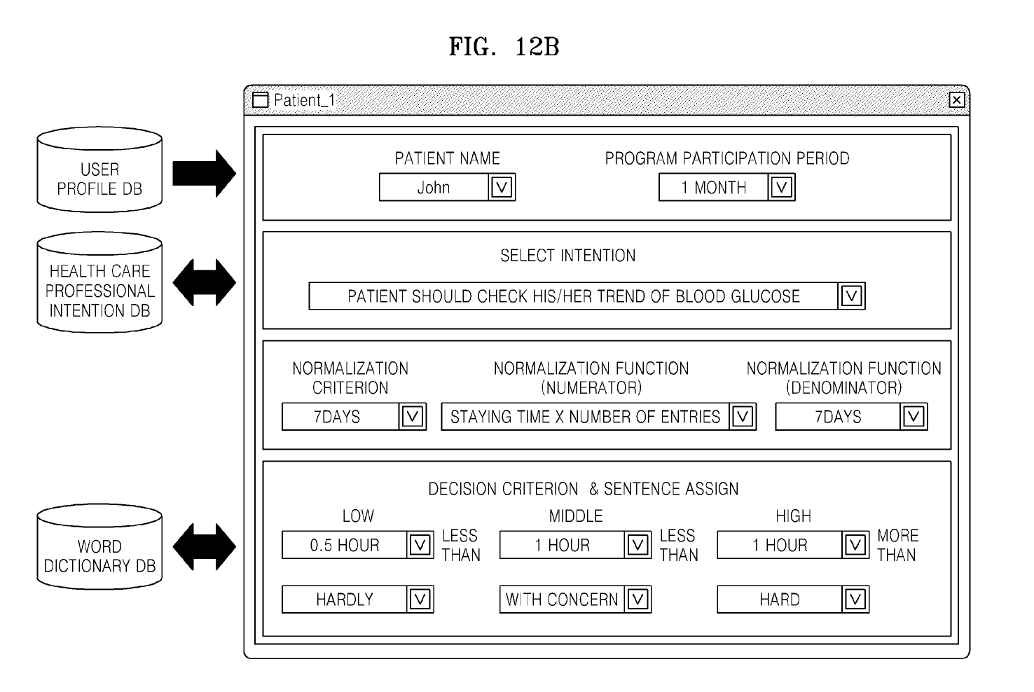

The health care professional intention extraction unit 570 extracts the health care professional intention stored in the health care professional intention DB 530 by normalizing the health care professional intention according to the normalization criterion, the normalization function, and the determination criterion. Examples of generating the health care professional intention are shown in FIGS. 12A and 12B.

FIG. 12A illustrates an operation of generating the health care professional intention. Referring to FIG. 12A, in operation 1210, at least one intention that indicates a user's target is selected and input by referring to the user profile DB 510 and a health care professional intention DB 530. In operation 1230, a health care professional intention is generated as a normalized value by applying a normalization criterion, a normalization function, and a determination criterion to the input health care professional intention. In operation 1250, a sentence factor is allocated to the health care professional intention that is generated as the normalized value, by referring to a word dictionary DB. In operation 1270, the health care professional intention to which the normalized value and the sentence factor are allocated is stored in the health care professional intention DB 530. In the present embodiment, operation 1250 may be optionally performed. An example of a sentence generated by the health care professional intention may include a sentence such as ‘A patient should check his/her blood glucose trend with concern.’, as illustrated in FIG. 12B.

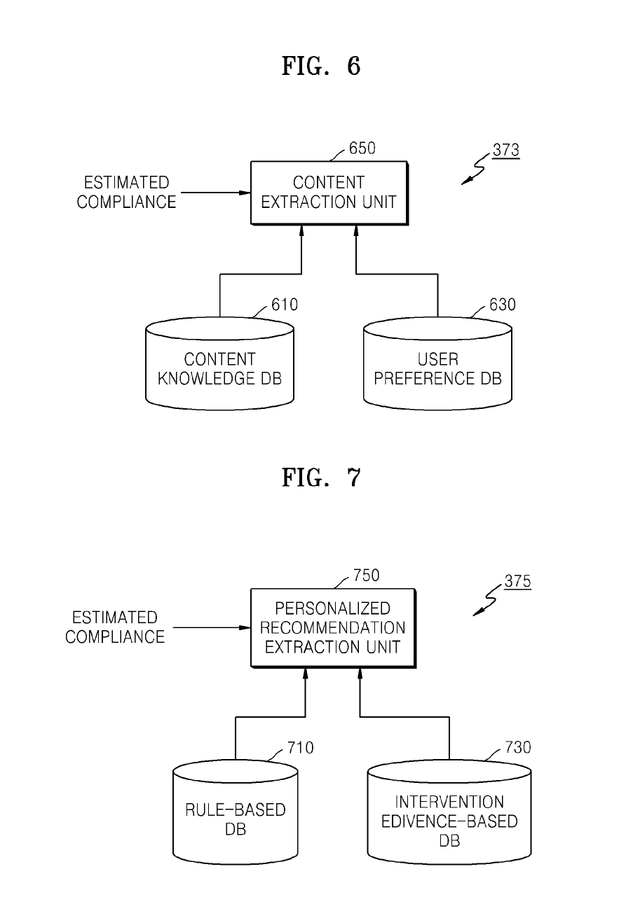

FIG. 6 is a detailed block diagram of the personalized content generation unit 373 illustrated in FIG. 3. Referring to FIG. 6, the personalized content generation unit 373 may include a content knowledge DB 610, a user preference DB 630, and a content extraction unit 650.

Health-related information that is collected by the health care professional 150, by a knowledge manager searching websites, or previously-stored health-related contents are classified and edited and stored in the content knowledge DB 610. In one embodiment, a health care professional intention may be allocated to and registered in the attribute of each of the contents.

User preference, such as the type of preferred contents, which is obtained through an interview between the health care professional 150 and the user 100 or between the knowledge manager and the user 100, for example, is stored in the user preference DB 630.

The contents extraction unit 650 extracts personalized contents that correspond to an intention difference generated by comparing a user intention and a health care professional intention with respect to contents, by inputting the estimated current compliance and by searching the content knowledge DB 610. In the present embodiment, the content knowledge DB 610 is searched by referring to the user preference stored in the user preference DB 630, thereby extracting the personalized contents that may attracts more attention from the user 100. In one embodiment, for users who do measurement well and do not see their trends, for example, contents such as news that emphasizes the importance of self-management, articles, or examples are extracted and provided to the health care terminal 130 of the user 100. When the attribute, i.e., contents that emphasize the importance of self-management, is registered, the health care professional 150 may connect the health care professional intention such as ‘a patient should check his/her blood glucose trend with concern’ to the user intention and may store the contents in the content knowledge DB 610.

FIG. 7 is a detailed block diagram of the personalized recommendation generation unit 375 illustrated in FIG. 3. Referring to FIG. 7, the personalized recommendation generation unit 375 may include a rule-based DB 710, an intervention evidence-based DB 730, and a personalized recommendation extraction unit 750. The intervention evidence-based DB 730 may be optionally provided.

A rule-based logic for generating the recommendation corresponding to the intention difference between the user intention and the health care professional intention is stored in the rule-based DB 710. The rule-based logic is previously designed by advanced simulation or experiments using a substantially large amount of statistical data.

A result of compliance that is obtained when intervention of the health care professional 150 is carried out in response to the intention difference between a plurality of users' intentions and the health care professional intention, i.e., intervention evidence information, is stored in the intervention evidence-based DB 730.

The personalized recommendation extraction unit 750 extracts a personalized recommendation corresponding to the intention difference generated by comparing the user intention and the health care professional intention, i.e. the estimated current compliance. In one embodiment, when the estimated current compliance is lowered, for example, a recommendation that may be maintained at a predetermined level may be extracted. Meanwhile, when the personalized recommendation is extracted according to users, future compliance of the user that is predicted from current compliance of the user may be used by using the intervention evidence information stored in the intervention evidence-based DB 730 or by adding the future compliance of the user to the current compliance of the user. In the present embodiment, the recommendation extraction unit 750 extracts the personalized recommendation corresponding to the current compliance of the user and/or the future compliance of the user by referring to the rule-based DB 710. In the present embodiment, when a recommendation in a form of a sentence is generated, a word dictionary DB (not shown) may be used. The recommendation may be in a form of a script, a diagram, or various other types of expressions. The recommendation may be extracted from a function item having the largest intention difference from among a plurality of function items included in the usage data of the user 100, so as to reduce the intention difference between the user 100 and the health care professional 150. The recommendation is transferred to the health care professional 150, and the heath care professional 150 may properly intervene, by various methods such as calling the user 100, sensing a short message, sending education data to the health care terminal 130, for example, for the purpose of encouraging or stimulating the user 100 in response to the recommendation.

Table 2 shows an embodiment in which intention difference amplification ratios are set in consideration of importance or a user's current situation with respect to each of function items or detailed items of each classification.

TABLE 2

| | | | | | | | Difference | |
|---|---|---|---|---|---|---|---|---|
| | | | | | Reference | | amplifica- | |
| | First | Second | Third | Fourth | value | Intention | tion ratio | Intention technology |
| | classification | classification | classification | classification | description | target | (0.5 to 2) | of Care Manager |
| Blood glucose | A | A | X | A | Three times | 100 | 1.5 | Initial habit should be |
| measurement | | | | | a day | | | formed and thus, amplification |
| | A | A | X | B | N/A | N/A | 1 | ratio 1.5 times of reference |
| | A | A | X | C | N/A | N/A | 1 | value is allocated. |
| Blood pressure | A | B | X | A | Twice a day | 100 | 1.5 | Complications, such as stroke |
| measurement | A | B | X | B | N/A | N/A | 1 | caused by hyperpiesia, may occur |
| | A | B | X | C | N/A | 100 | 1 | and thus, formation of blood |
| | | | | | | . . . | | pressure management habit is |
| | | | | | | . . . | | needed, and amplification ratio |
| | | | | | | | | 1.5 times of reference value is |
| | | | | | | | | allocated . . . |
| Education | C | A | A | A | Four times a | 100 | 1 | Reinforcement of education is |
| | | | | | week | | | required through scaring of |
| | C | A | A | B | Ten minutes | 100 | 1 | complications due to long-term |
| | | | | | per once | | | chronic disease, and thus |
| | C | A | A | C | Five times per | 100 | 1 | amplification ratio of 2.0 |
| | | | | | once | | | with respect to diabetes |
| | C | A | B | A | Twice a week | 100 | 2 | prevention education is allocated. |
| | C | A | B | B | Ten minutes | 100 | 1 | Amplification ratio with |
| | | | | | per once | | | respect to education for |
| | C | A | B | C | Five times per | 100 | 1 | correcting living habits is set |
| | | | | | once | | | as 1.5. |
| | C | A | C | A | Once a week | 100 | 1.5 | Complications, such as a stroke, |
| | C | A | C | B | Ten minutes | 100 | 1 | may occur, and thus, amplification |
| | | | | | per once | | | ratio with respect to diabetes |
| | C | A | C | C | Five times per | 100 | 1 | prevention education is set as 2. |
| | | | | | once | | | |
| | C | B | A | A | Four times | 100 | 1 | |
| | | | | | a week | | | |
| | C | B | A | B | Ten minutes | 100 | 1 | |
| | | | | | per once | | | |
| | C | B | A | C | Five times per | 100 | 1 | |
| | | | | | once | | | |
| | C | B | B | A | Twice a week | 100 | 2 | |
| | C | B | B | B | Ten minutes | 100 | 1 | |
| | | | | | per once | | | |
| | C | B | B | C | Five times | 100 | 1 | |
| | | | | | per once | | | |
| | C | B | C | A | Once a week | 100 | 1 | |
| | C | B | C | B | Ten minutes | 100 | 1 | |
| | | | | | per once | | | |
| | C | B | C | C | Five times per | 100 | 1 | |
| | | | | | once | | | |
| | | | | | | . . . | | |
| | | | | | | . . . | | |

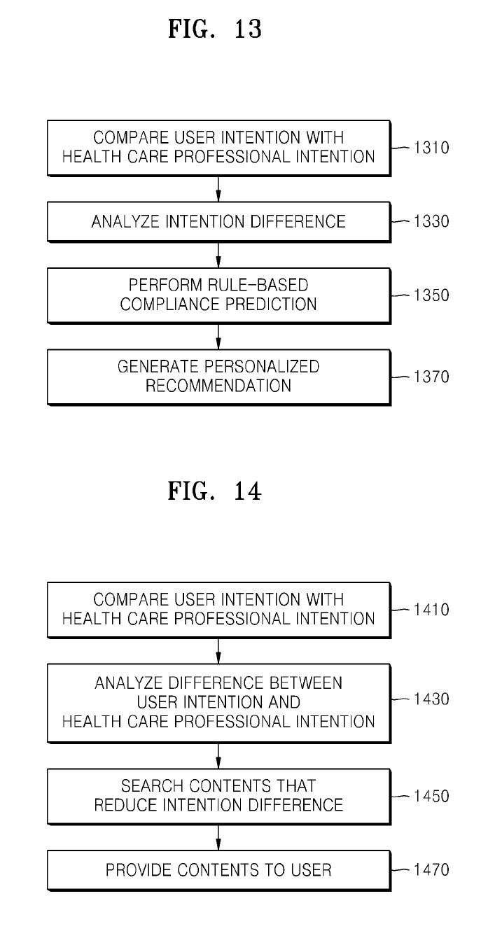

FIG. 13 is a flowchart illustrating an embodiment of an operation of generating a personalized recommendation, according to the present disclosure.

Referring to FIG. 13, in operation 1310, the user intention which is generated from the usage data of the user 100 that is generated due to the interaction between the health care terminal 130 and the user 100, and the health care professional intention that indicates a target instruction for the user are compared with each other.

In operation 1330, a difference between the health care professional intention and the user intention is analyzed. In the present embodiment, the same normalization criterion, a substantially same normalization function, and a substantially same determination criterion are applied to the health care professional intention and the user intention, resultantly the health care professional intention and the user intention may be normalized and represented as values. By analyzing a difference between the normalized values, the current compliance of the user with respect to remote health care management is estimated.

In operation 1350, by referring to the estimated current compliance of the user, the rule-based logic stored in the rule-based DB 710 and the intervention evidence information stored in the intervention evidence-based DB 730, the future compliance of the user is predicted. Operation 1350 may be optionally performed.

In operation 1370, a personalized recommendation corresponding to at least one of the estimated current compliance of the user and the predicted future compliance of the user is generated.

FIG. 14 is a flowchart illustrating an embodiment of an operation of generating personalized contents, according to the present disclosure. Referring to FIG. 14, in operation 1410, the user intention which is generated from the usage data of the user 100 generated due to the interaction between the health care terminal 130 and the user 100, and the health care professional intention that indicates the target instruction for the user are compared.

In operation 1430, a difference between the health care professional intention and the user intention is analyzed. In detail, an intention difference in contents may be used. In the present embodiment, a substantially same normalization criterion, a substantially same normalization function, and a substantially same determination criterion are applied to the health care professional intention and the user intention, and thus, the health care professional intention and the user intention may be normalized and represented as values. By analyzing a difference between the normalized values, the current compliance of the user with respect to remote health care management is estimated.

In operation 1450, by searching the content knowledge DB 610, personalized contents corresponding to the current compliance of the user are searched. In this case, by referring to the user preference stored in the user preference DB 630, the personalized contents attracting more attention from the user may be searched.

In operation 1470, the personalized contents searched in operation 1450 are provided to the health care terminal 130.

As described above, according to the one or more of the above embodiments of the present invention, usage data of a user about a remote health care management program recorded on a remote health care terminal can be collected in real-time, and a user intention can be extracted from the collected usage data of the user, and user compliance with respect to remote health care management can be continuously monitored from a difference between the extracted user intention and a health care professional intention. In one embodiment, personalized recommendation and contents that may reduce a difference between the user intention and the health care professional intention using the result of monitoring the user compliance with respect to the remote health care management, can be extracted so that rapid and adaptive action for the lowered user compliance with respect to the remote health care management can be taken. As such, the user can maintain compliance at a predetermined level with respect to the remote health care management, and if necessary, the user compliance can be improved, and as such, a health status or disease of the user who uses the remote health care terminal can be substantially improved.

In addition, other embodiments of the present invention can also be implemented through computer readable code/instructions in/on a medium, e.g., a computer readable medium, to control at least one processing element to implement any of the above described embodiments. The medium can correspond to any medium/media permitting the storage and/or transmission of the computer readable code.

The computer readable code can be recorded/transferred on a medium in a variety of ways, with examples of the medium including recording media, such as magnetic storage media, e.g., read-only memory (“ROM”), floppy disks, hard disks, etc and optical recording media, e.g., compact disc read-only memory (“CD-ROM”), or digital versatile disc (“DVD”), and transmission media such as a network transmission media.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A remote health care method, the method comprising:
generating a user intention from usage data of a user provided by a health care terminal;
generating a health care professional intention about the user;
generating a personalized recommendation which adjusts compliance of the user with respect to remote health care management based on the user intention and the health care professional intention; and
providing the personalized recommendation to at least one of the health care terminal and a health care professional.

2. The method of claim 1, further comprising
generating personalized content which adjusts compliance of the user with respect to the remote health care management based on the user intention and the health care professional intention; and
providing the personalized content to the health care terminal.

3. The method of claim 1, further comprising
reconfiguring a remote health care management program based on a difference between the user intention and the health care professional intention; and
providing the reconfigured remote health care management program to the health care terminal.

4. The method of claim 1, wherein the generating of the personalized recommendation comprises:
comparing the user intention and the health care professional intention;
estimating current compliance of the user from a difference between the user intention and the health care professional intention; and
extracting the personalized recommendation corresponding to the current compliance of the user.

5. The method of claim 4, further comprising:
predicting future compliance of the user by referring to intervention evidence information, wherein the personalized recommendation corresponding to at least one of the current compliance of the user and future compliance of the user is extracted.

6. The method of claim 2, wherein the generating of the personalized content comprises:
comparing the user intention and the health care professional intention;
analyzing a difference between the user intention and the health care professional intention; and
extracting the personalized content corresponding to a result of the analyzing.

7. The method of claim 6, wherein the personalized content is extracted by further reflecting a user preference.

8. The method of claim 1, wherein the user intention corresponding to the health care professional intention is normalized by applying a substantially same normalization criterion, a substantially same normalization function, and a substantially same determination criterion as that of the health care profession intention to the user intention.

9. A remote health care system comprising:
a health care terminal generating information generated due to user's interaction with respect to at least one of a function and content included in a remote health care management program as usage data of the user; and
a server generating a user intention from the usage data of the user provided by the health care terminal, generating a health care professional intention about the user, and generating a personalized recommendation which adjusts compliance of the user with respect to remote health care management based on the user intention and the health care professional intention.

10. The system of claim 9, wherein the health care terminal generates the user intention from the usage data of the user and generates the personalized recommendation based on a difference between a previously-stored health care professional intention and the user intention.

11. The system of claim 9, wherein the user intention corresponding to the health care professional intention is normalized by applying a substantially same normalization criterion, a substantially same normalization function, and a substantially same determination criterion as that of the health care professional intention to the user intention.

12. A server for remote health care management, the server comprising:
a user intention generation unit which generates a user intention from usage data of a user provided by a health care terminal;
a health care professional intention generation unit which generates a health care professional intention about the user; and
a compliance adjustment unit which generates at least one of a personalized recommendation and personalized content which adjust compliance of the user with respect to the remote health care management based on the user intention and the health care professional intention.

13. The server of claim 12, wherein the compliance adjustment unit comprises:
a compliance estimation unit which estimates the compliance of the user from a difference between the user intention and the health care professional intention;
a personalized content generation unit which generates the personalized content using the estimated compliance; and
a personalized recommendation generating unit which generates the personalized recommendation using the estimated compliance.

14. The server of claim 12, wherein the compliance adjustment unit obtains a final difference by applying an amplification ratio to a predetermined function item when at least one of a health care professional and a knowledge manager sets the amplification ratio in advance with respect to the predetermined function or a content item according to an importance of each function item included in the remote health care management program and the difference between the user intention and the health care professional intention related to the predetermined function item is obtained.

15. The server of claim 12, wherein the compliance adjustment unit compares the user intention with the health care professional intention, analyzes a difference between the user intention and the health care professional intention, and extracts a personalized recommendation corresponding to a result of the analyzing in consideration of user preference.

16. The server of claim 12, wherein the compliance adjustment unit compares the user intention with the health care professional intention, estimates current compliance of the user corresponding to a difference between the user intention and the health care professional intention, predicts future compliance of the user by referring to intervention evidence information, and extracts the personalized recommendation corresponding to at least one of the current compliance of the user and the future compliance of the user.

17. The server of claim 12, wherein the user intention corresponding to the health care professional intention is normalized by applying a substantially same normalization criterion, a substantially same normalization function, and a substantially same determination criterion as that of the health care professional intention to the user intention.

18. A health care terminal comprising:
a user interface unit which displays at least one of a function and content included in a remote health care management program and performs an interaction of a user with respect to at least one of the displayed function and content; and
a data processing unit which generates usage data of the user due to the interaction of the user performed by the user interface unit, and performs at least one of storing the usage data of the user and transmitting the usage data of the user to a server disposed at a remote place.

19. The health care terminal of claim 18, further comprising a storage unit to store the remote health care management program and a health care professional intention, wherein the data processing unit generates a user intention from the usage data of the user and generates a personalized recommendation based on a difference between the health care professional intention and the user intention.

20. The health care terminal of claim 18, further comprising a communication unit to receive at least one of a personalized recommendation and content provided by the server.
